(19) United States
(12) Patent Application Publication
(10) Pub. No.: US 2022/0041146 A1
(43) Pub. Date: Feb. 10, 2022

(54) Systems and Methods for Emergency Braking in Autonomous Vehicles

(71) Applicant: UATC, LLC, San Francisco, CA (US)

(72) Inventors: Frederic Tschanz, Pittsburgh, PA (US); Paul Theodosis, Santa Clara, CA (US); David McAllister Bradley, Pittsburgh, PA (US)

(21) Appl. No.: 17/062,168

(22) Filed: Oct. 2, 2020

Related U.S. Application Data
(60) Provisional application No. 63/062,788, filed on Aug. 7, 2020.

(51) Int. Cl. B60T 8/32; B60T 7/22; B60T 8/171; B60T 8/172; B60T 8/58; G05D 1/00; G05D 1/02

(52) U.S. Cl. CPC B60T 8/3205; B60T 7/22; B60T 8/171; B60T 8/172; G05D 2201/0213; G05D 1/0088; G05D 1/0223; B60T 2210/32; B60T 2250/00; B60T 8/58

(57) ABSTRACT

The present disclosure is directed towards a system for implementing emergency braking. In particular, a computing system can obtain current trajectory data from a motion planning system of an autonomous vehicle. The computing system can determine whether an emergency braking flag within the current trajectory data is set to true based at least in part on the current trajectory data. The computing system can, in response to determining that the emergency braking flag within the current trajectory data is set to true, change a current braking mode of the autonomous vehicle from a first braking mode to a second braking mode. While in the second braking mode, the computing system can set a current acceleration value to the second maximum stopping rate. The computing system can transmit the current acceleration value for implementation by the autonomous vehicle.

### RELATED APPLICATION

This application claims priority to and the benefit of U.S. Provisional Patent Application No. 63/062,788, filed Aug. 7, 2020, which is hereby incorporated by reference in its entirety.

### FIELD

The present disclosure relates generally to autonomous vehicles. More particularly, the present disclosure relates to motion control for autonomous vehicles.

### BACKGROUND

An autonomous vehicle is a vehicle that is capable of sensing its environment and navigating without human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path for navigating through such surrounding environment.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include obtaining, by a vehicle controller comprising one or more processors, current trajectory data from a motion planning system of an autonomous vehicle. The method can include determining, by the vehicle controller, whether an emergency braking flag within the current trajectory data is set to true based at least in part on the current trajectory data. The method can include, in response to determining that the emergency braking flag within the current trajectory data is set to true, changing, by the vehicle controller, a current braking mode of the autonomous vehicle from a first braking mode to a second braking mode, wherein the first braking mode is associated with a first maximum stopping rate and the second braking mode is associated with a second maximum stopping rate. While in the second while in the second braking mode, the method can include disabling, by the vehicle controller, longitudinal feedback control of the autonomous vehicle and setting, by the vehicle controller, a current acceleration value to the second maximum stopping rate. The method can include transmitting, by the vehicle controller, the current acceleration value for implementation by the autonomous vehicle.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts a block diagram of an example autonomous vehicle according to example embodiments of the present disclosure.

FIG. 2A depicts a diagram of an example system including a plurality of devices configured to execute one or more processes according to example implementations of the present disclosure.

FIG. 2B depicts a diagram of an example functional graph according to example implementations of the present disclosure.

FIG. 2C depicts a block diagram of an example motion planning system according to example embodiments of the present disclosure.

FIG. 3 depicts an example of a vehicle controller according to example embodiments of the present disclosure.

FIG. 4 depicts an example motion planning scenario according to example embodiments of the present disclosure.

FIG. 5 depicts an example diagram for a vehicle controller subsystem 500 associated with determining whether the emergency braking flag is set according to example embodiments of the present disclosure.

FIG. 6 depicts an example autonomous vehicle response subsystem 600 according to example embodiments of the present disclosure.

FIG. 7 depicts a flow chart diagram of an example method according to example embodiments of the present disclosure.

FIG. 8 depicts an example system with units for performing operations and functions according to example aspects of the present disclosure.

FIG. 9 depicts example system components according to example aspects of the present disclosure.

### DETAILED DESCRIPTION

This application is directed to improving the braking ability of autonomous vehicles in emergency situations. Autonomous vehicles can include a vehicle computing system that generates a planned path and then, based on the planned path, the vehicle computing system can transmit trajectory data to a vehicle controller (e.g., a vehicle interface module (VIM), etc.) to help translate the trajectory into commands for the acceleration, braking, and steering of the autonomous vehicle. The vehicle computing system can attempt to minimize the difference between the planned result of the trajectory data and the actual result of the vehicle control commands by generating estimates of the acceleration, stopping, and steering characteristics of the autonomous vehicle. In some examples, these estimates can be based on the specific characteristics associated with the particular make, model, size, shape, version, etc. of the autonomous vehicle.

For example, specific autonomous vehicles (e.g., different vehicle models) have specific theoretical stopping rate maximums. A stopping rate represents how quickly the autonomous vehicle can reduce its velocity using braking mechanisms included in the autonomous vehicle. However, in practice, the actual ability of a given model of autonomous vehicle to reduce its velocity is noticeably lower than the theoretical maximum. To ensure that the vehicle computing system can reliably and safely predict the stopping characteristics of the autonomous vehicle, the vehicle computing system can use a conservative estimate to internally represent how quickly the autonomous vehicle can reduce its velocity. Thus, using the conservatively estimated stopping rate can allow the autonomous vehicle to accurately predict the actual stopping rate of the autonomous vehicle.

In some situations, the autonomous vehicle may need to stop at a rate that exceeds the conservatively estimated stopping rate. For example, if an obstacle suddenly moves into the path of the autonomous vehicle, the vehicle computing system can determine a target stopping rate that exceeds the conservatively estimated stopping rate. In this context, the goal of the autonomous vehicle can change from ensuring the accurate prediction of a stopping rate to stopping the autonomous vehicle as quickly as possible. To do so, the autonomous vehicle can engage the maximum possible stopping rate without regard to whether it can accurately predict the actual stopping rate that will result.

Thus, if the motion planner included in the vehicle computing system determines that the target stopping rate exceeds the conservatively estimated stopping rate, the motion planner can set an emergency braking flag when transmitting trajectory data (e.g., associated with a specific planned trajectory or specific control commands) to the vehicle controller (e.g., the VIM). In this context, a flag can refer to any data or signal transmitted from the motion planner to the vehicle controller that has been previously designated to communicate whether the motion controller should enter an emergency braking mode. Thus the flag can be one or more predetermined bits of data included in the trajectory data or a signal distinct from the trajectory data. In some examples, the flag can have a Boolean data type such that the flag can be set to true or false directly. In other examples, the autonomous vehicle or an associated system can predetermine that a particular value or range of values for the data or signal can represent true and another value or range of values can represent false.

The vehicle controller can, when receiving trajectory data, determine whether the emergency braking flag has been set to true. If the emergency braking flag has been set to true, the vehicle controller can change from a first braking mode to a second braking mode. While in the first braking mode, the autonomous vehicle will attempt to reduce its speed at the conservative estimate associated with the autonomous vehicle (e.g., based on the specific physical parameters of the vehicle). While in the second braking mode, the vehicle controller can use all possible braking mechanisms in an attempt to reduce velocity as quickly as possible. To facilitate the maximum reduction in velocity, the autonomous vehicle can cease tracking longitudinal feedback (which uses feedback about the distance travel to adjust the stopping rate) and disregard any accrued longitudinal error.

In a basic example of the disclosed systems and methods, an autonomous vehicle can use a vehicle computing system to plan a path for an autonomous vehicle. The vehicle computing system can determine that an obstacle has unexpectedly appeared in the path of the autonomous vehicle. In response, the vehicle computing system can determine that the stopping rate that would prevent collision exceeds the conservatively estimated stopping rate. In response, the vehicle computing system (e.g., a motion planner) can generate one or more vehicle controls with an emergency braking flag set to true. The vehicle controls can be transmitted to a vehicle controller.

The vehicle controller can determine that the emergency braking flag has been set to true. As a result, the vehicle controller can engage the braking mechanisms at full capability and disable the existing feedback and error-correcting mechanisms until the autonomous vehicle comes to a stop.

More specifically, the above-described emergency braking system can be included in an autonomous vehicle (e.g., ground-based vehicle, aerial vehicle, etc.). An autonomous vehicle can include a vehicle computing system. The vehicle computing system can be responsible for, among other functions, creating the control signals needed to effectively control an autonomous vehicle. The vehicle computing system can include an autonomy computing system. The autonomy computing system can include one or more systems that enable the autonomous vehicle to plan and/or follow a given route, receive sensor data about the environment, perceive objects within the vehicle's surrounding environment (e.g., other vehicles), predict the motion of the objects within the surrounding environment, and generate trajectories for the vehicle to follow based on the route/perceived objects/predicted object motion. The autonomy system can output data indicative of the generated trajectories and corresponding control signals can be sent to vehicle control system(s) (e.g., acceleration, steering, braking, etc. systems) to enable the autonomous vehicle to autonomously navigate (e.g., to its target destination).

To accomplish these operations, the autonomy computing system can include, for example, a perception system, a prediction system, and a motion planning system. Many of the functions performed by the perception system, prediction system, and motion planning system can be performed, in whole or in part, by one or more machine-learning models. Moreover, one or more of the perception system, the prediction system, and/or the motion planning system (or the functions associated therewith) can be combined into a single system and/or share computing resources.

To help maintain awareness of the vehicle's surrounding environment, the vehicle computing system can access sensor data from one or more sensors (e.g., LIDAR, RADAR, camera, etc.) to identify static objects and/or dynamic objects (actors) in the autonomous vehicle's environment. To help determine its position within the environment (and relative to these objects), the vehicle computing system can provide sensor data to one or more machine-learned model(s). In addition or alternatively, the autonomous vehicle can access map data (e.g., high definition map data, etc.) to determine the autonomous vehicle's current position relative to other objects in the world (e.g., bicycles, pedestrians, other vehicles, buildings, etc.), as well as map features such as, for example, lane boundaries, curbs, and so on.

The computing system of an autonomous vehicle can include a plurality of devices (e.g., physically-connected devices, wirelessly-connected devices, virtual devices running on a physical machine, etc.) that implement a software graph architecture of the autonomous vehicle. For instance, the plurality of computing devices can implement the vehicle's autonomy software that helps allow the vehicle to autonomously operate within its environment. Each device can include a compute node configured to run one or more processes. A process can include a plurality of function nodes (e.g., software functions) connected by one or more directed edges that dictate the flow of data between the plurality of function nodes. A device can execute (e.g., via one or more processors, etc.) a respective plurality of function nodes to run a respective process. The plurality of processes can be collectively configured to perform one or more tasks or services of the computing system. To do so, the plurality of processes can be configured to communicate (e.g., send/receive messages) with each other over one or more communication channels (e.g., wired and/or wireless networks). By way of example, with respect to the vehicle's onboard computing system, its processes (and their respective function nodes) can be organized into a directed software graph architecture (e.g., including sub-graphs) that can be executed to communicate and perform the operations of the autonomous vehicle (e.g., for autonomously sensing the vehicle's environment, planning the vehicle's motion, etc.).

The vehicle computing system can utilize the sensor data to identify one or more objects in the local environment of the autonomous vehicle. Using this sensor data, the vehicle computing system can generate perception data that describes one or more object(s) in the vicinity of the autonomous vehicle (e.g., current location, speed, heading, shape/size, etc.).

The generated perception data can be utilized to predict the future motion of the object(s). For example, the vehicle computing system can use the perception data to generate predictions for the movement of one or more objects as an object trajectory including one or more future coordinates/points. In some implementations, the perception and prediction functions of the vehicle computing system can be included within the same system.

The vehicle computing system can use the perception data, prediction data, map data, and/or other data to generate a motion plan for the vehicle. As noted above, one part of generating a motion plan can include determining a stopping rate for the autonomous vehicle during a specific trajectory. If the stopping rate exceeds a conservatively estimated stopping rate, the vehicle computing system can set an emergency braking flag included in the trajectory data that is sent to a vehicle controller. The vehicle controller can include a vehicle interface module (VIM) that can obtain data from one or more vehicle systems such as the autonomy system (e.g. the motion planner) and/or other systems. The vehicle control can also communicate with other systems to receive feedback data, as further described herein. The vehicle controller can utilize the data it obtains and interface with the vehicle control system(s) to help implement trajectories for the vehicle to follow. For example, the autonomous vehicle can select and implement a trajectory for the autonomous vehicle to navigate a specific segment of the route. The vehicle controller can translate motioning plan/trajectory data into instructions for controlling the autonomous vehicle including adjusting the steering of vehicle “X” degrees, applying a certain magnitude of braking force, etc. The vehicle control system(s) can generate specific control signals for the autonomous vehicle (e.g., adjust steering, braking, velocity, and so on). The specific control signals can cause the autonomous vehicle to move in accordance with the selected trajectory.

The vehicle controller can have other functions such as, for example, implementing an emergency braking operation. As further described herein, based on the emergency braking flag, the vehicle controller can switch the autonomous vehicle into an emergency braking mode (e.g., second braking mode). While in the emergency braking mode, the vehicle controller (or an associated braking system) can use all possible braking systems to reduce the velocity of the autonomous vehicle as quickly as possible.

To ensure that the autonomous vehicle can stop appropriately, the autonomous vehicle can include a motion planner that determines a stopping rate for a particular trajectory and transmits the trajectory data to a vehicle controller. The motion planner can include a trajectory analysis system and a trajectory data generator.

The trajectory analysis system can access position data for one or more obstacles and map data for an environment around the autonomous vehicle. Based on this information, the trajectory analysis system can generate one or more candidate trajectories. Each of the candidate trajectories can be evaluated based on a cost associated with performing each trajectory. A particular trajectory can be selected as having the lowest cost.

A trajectory data generator can generate trajectory data to be sent to the vehicle controller. The trajectory data generator can include a stopping rate determination system and a flag setting system. The stopping rate determination system can determine, based on the selected trajectory, a target stopping rate that represents how quickly the autonomous vehicle must slow down to safely avoid a collision. In some examples, the selected trajectory can include a high stopping rate in response to a nearby obstacle.

The stopping rate determination system can determine whether the target stopping rate exceeds a first stopping rate. The first stopping rate can be a conservatively estimated stopping rate that can be achieved reliably and consistently by the autonomous vehicle. For example, a conservatively estimated stopping rate can be a rate that is lower than the maximum theoretical stopping rate of the autonomous vehicle. For example, if the calculated theoretical stopping rate for an autonomous vehicle is 5 m/s² the autonomous vehicle may not always be able to stop at the rate. Instead, the actual measured stopping rate that the autonomous vehicle can reliably reach is 3.5 m/s². As a result, the autonomous vehicle can establish 3.5 m/s² as a stopping rate that the autonomous vehicle can consistently meet.

The flag setting system can, based on the determination whether the target stopping rate exceeds the first stopping rate, set an emergency braking flag included in the trajectory data that is sent to the vehicle controller.

The vehicle controller can include a flag analysis system, a mode determination system, and a braking command system. The flag analysis system can, among other things, determine whether the emergency braking flag is set to true. The mode determination system can set the braking mode of the autonomous vehicle based on whether or not the emergency braking flag is set to true. The mode determination system can set the braking mode of the vehicle to the first braking mode if the emergency braking flag is set to false. The first braking mode can be associated with the normal operation of the autonomous vehicle. While in the first braking mode, the maximum stopping rate is a conservatively estimated stopping rate.

In addition, while in the first braking mode, the vehicle controller can receive longitudinal feedback control. Longitudinal feedback control can include measuring the longitudinal progress of the autonomous vehicle (e.g., how far the autonomous vehicle moves in a forward direction). In this way, if the longitudinal progress of the autonomous vehicle is greater than or less than the projected distance, the vehicle controller can adjust one or more braking commands to ensure that the autonomous vehicle meets the targeted stopping rate.

In addition, while in the first braking mode the vehicle controller can measure the current velocity of the autonomous vehicle and determine whether the current velocity has diverged from the target velocity. This information can be used to correct the commands/control signals to ensure that the planned velocity and the actual velocity match.

The mode determination system can set the braking mode to a second braking mode if the emergency braking flag is set to true. The second braking mode can be an emergency braking mode. While in the second braking mode the mode determination system can disable longitudinal feedback control and discard any error tracking. Instead, while in the second braking mode the braking system attempts to stop the autonomous vehicle as quickly as possible.

Once the mode determination system determines the appropriate braking mode, the braking command system can generate one or more braking command signals for controlling the stopping rate of the vehicle. The first braking mode is associated with a first maximum stopping value (e.g., the conservatively estimated stopping value). In some examples, while in the first mode, the stopping rate is less than the maximum stopping rate. The second braking mode can be associated with a second maximum stopping rate. In some examples, the second maximum stopping rate can be the theoretical stopping rate of the autonomous vehicle.

The braking command system can select a particular stopping rate (e.g., for the particular mode) and generate command signal(s) to achieve the stopping rate. For instance, the command signal(s) can be provided to a brake control system of the autonomous vehicle (e.g., electronic control system, etc.) that can control the vehicle's brakes based at least in part on the command signal(s).

The following provides an end-to-end example of the technology described herein. An autonomous vehicle can include a vehicle computing system. The vehicle computing system can include the motion planner and vehicle controller as described herein. The vehicle computing system can obtain current trajectory data from a motion planning system of an autonomous vehicle. In some examples, the current trajectory data comprises target acceleration data. The target acceleration data can include a rate at which the vehicle is expected to stop, slow down, or otherwise decelerate.

In some examples, the trajectory data includes an expected trajectory for the autonomous vehicle. The expected trajectory contains a target progression of the autonomous vehicle over a given amount of time. For example, the trajectory can include a series of target coordinates, each coordinate representing the ideal location of the autonomous vehicle at each of a series of points in time (e.g., 1 second, 2 seconds, 3 seconds, and so on). In some examples, the target progression includes a target velocity, a target acceleration, a target heading, and a target pose for the autonomous vehicle at one or more points in time.

The vehicle computing system can determine whether an emergency braking flag within the current trajectory data is set to true based at least in part on the current trajectory data. In some examples, the emergency braking flag indicates the target acceleration data exceeds the first maximum stopping rate. In some examples, the emergency braking flag is set based on a comparison between the target acceleration data and the first maximum stopping rate, such that if the target acceleration data exceeds the first maximum stopping rate, the emergency braking flag is set. Additionally, or alternatively, the emergency braking flag can be set when the vehicle computing system determines that the autonomous vehicle has not been able to meet a target stopping rate. For example, a target stopping rate may be 1.0 m/s². The motion planner can send trajectory data to cause the autonomous vehicle to stop at the target stopping rate. The motion planner can then monitor the actual stopping rate of the autonomous vehicle. If the actual stopping rate fails to meet the target stopping rate for a predetermined amount of time (allowing the autonomous vehicle a period to reach the target stopping rate), the motion planner can set the emergency braking flag to true to avert potential problems that might result from failing to meet the target stopping rate within a predetermined amount of time.

In response to determining that the emergency braking flag within the current trajectory data is set to true, the vehicle computing system can change a current braking mode from a first braking mode to a second braking mode. The first braking mode can be associated with a first maximum stopping rate and the second braking mode can be associated with a second maximum stopping rate. In some examples, the first braking mode is a standard braking mode and the second braking mode is an emergency braking mode.

In some examples, the first maximum stopping rate can represent a less rapid stopping rate than the second maximum stopping rate. In some examples, the first maximum stopping rate and the second maximum stopping rate can be based on a specific make and model associated with the autonomous vehicle. While in the first braking mode, the vehicle computing system can receive velocity error feedback and heading error feedback and can update one or more control messages based on the velocity error feedback and the heading error feedback.

While in the second braking mode, the vehicle computing system can disable longitudinal feedback control of the autonomous vehicle and set a current acceleration value to the second maximum stopping rate. In addition, while in second braking mode the vehicle computing system can discard one or more stored control error variables. The vehicle computing system can measure an actual stopping rate for the autonomous vehicle once the current acceleration value has been transmitted to the vehicle control system. The vehicle computing system can transmit the actual stopping rate to a motion planner for use in motion planning. The vehicle computing system can transmit the current acceleration value to a vehicle control system for implementation by the autonomous vehicle.

Various means can be configured to perform the methods and processes described herein. For example, a computing system can include data access unit(s), flag evaluation unit(s), mode determination unit(s), feedback disablement unit(s), data transmission unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain current trajectory data from a motion planning system of an autonomous vehicle. For example, a vehicle controller can receive data describing a particular trajectory for the autonomous vehicle including an acceleration value, one or more destination coordinates, one or more steering commands, and so on. A data access unit is one example of a means for obtaining current trajectory data from a motion planning system of an autonomous vehicle.

The means can be configured to determine whether an emergency braking flag within the current trajectory data is set to true based at least in part on the current trajectory data. The vehicle controller can analyze the trajectory data to determine whether or not the emergency braking flag is set to true. A flag evaluation unit is one example of a means for determining whether an emergency braking flag within the current trajectory data is set to true based at least in part on the current trajectory data.

The means can be configured to, in response to determining that the emergency braking flag within the current trajectory data is set to true, change a current braking mode from a first braking mode to a second braking mode. For example, the vehicle controller can change the autonomous vehicle into an emergency braking mode (e.g., the second braking mode) when the trajectory data indicates that it is necessary. A mode determination unit is one example of a means for, in response to determining that the emergency braking flag within the current trajectory data is set to true, changing a current braking mode from a first braking mode to a second braking mode, wherein the first braking mode is associated with a first maximum stopping rate and the second braking mode is associated with a second maximum stopping rate.

The means can be configured to, while in the second braking mode, disable longitudinal feedback control of the autonomous vehicle and set a current acceleration value to the second maximum stopping rate. For example, the vehicle controller can cease using feedback from the sensors that measure the performance of the vehicle (e.g., based on the position of the autonomous vehicle) and set the braking value to the maximum possible stopping rate. A feedback disablement unit is one example of a means for, while in the second braking mode, disabling longitudinal feedback control of the autonomous vehicle, and setting a current acceleration value to the second maximum stopping rate.

The means can be configured to transmit the current acceleration value to a vehicle control system for implementation by the autonomous vehicle. The vehicle controller transmits command signals to the vehicle control system to be implemented by the autonomous vehicle itself. A data transmission unit is one example of a means for transmitting the current acceleration value to a vehicle control system for implementation by the autonomous vehicle.

The systems and methods described herein provide a number of technical effects and benefits. More particularly, the systems and methods of the present disclosure provide improved techniques for effective braking for autonomous vehicles in emergency situations. The disclosed system allows a braking system to normally operate in a conservative braking mode such that the estimated stopping rates are very reliable. However, the braking system can switch into an emergency braking mode when necessary, and thereby potentially achieve higher stopping rates. As such, the disclosed system improves both the predictability of the braking system in normal situations and the safety of the autonomous vehicle in emergency stopping situations.

With reference to the figures, example embodiments of the present disclosure will be discussed in further detail.

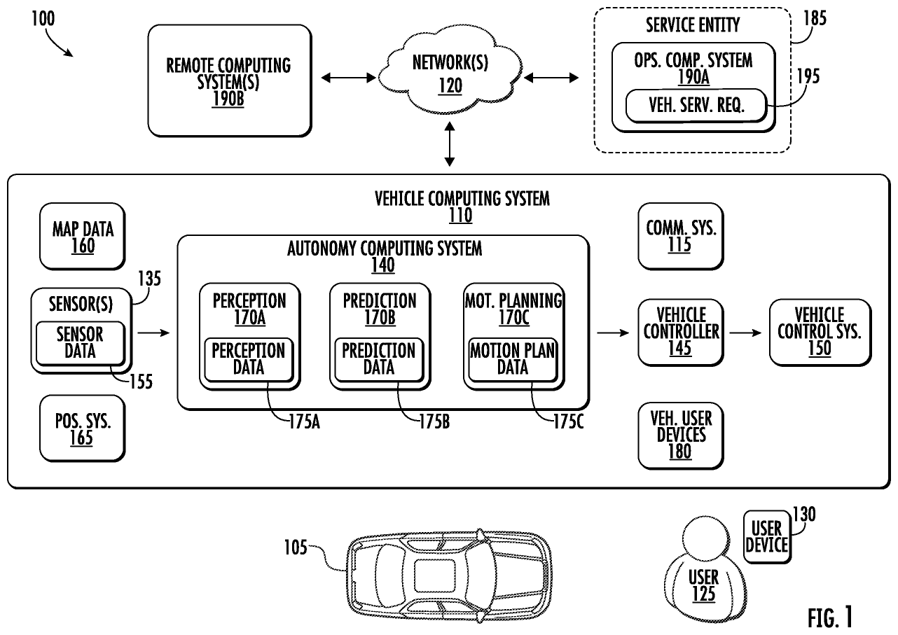

FIG. 1 depicts a block diagram of an example system 100 for controlling and communicating with a vehicle according to example aspects of the present disclosure. As illustrated, FIG. 1 shows a system 100 that can include a vehicle 105 and a vehicle computing system 110 associated with the vehicle 105. The vehicle computing system 110 can be located onboard the vehicle 105 (e.g., it can be included on and/or within the vehicle 105).

The vehicle 105 incorporating the vehicle computing system 110 can be various types of vehicles. For instance, the vehicle 105 can be an autonomous vehicle. The vehicle 105 can be a ground-based autonomous vehicle (e.g., car, truck, bus, etc.). The vehicle 105 can be an air-based autonomous vehicle (e.g., airplane, helicopter, vertical take-off and lift (VTOL) aircraft, etc.). The vehicle 105 can be a lightweight elective vehicle (e.g., bicycle, scooter, etc.). The vehicle 105 can be another type of vehicle (e.g., watercraft, etc.). The vehicle 105 can drive, navigate, operate, etc. with minimal and/or no interaction from a human operator (e.g., driver, pilot, etc.). In some implementations, a human operator can be omitted from the vehicle 105 (and/or also omitted from remote control of the vehicle 105). In some implementations, a human operator can be included in the vehicle 105.

The vehicle 105 can be configured to operate in a plurality of operating modes. The vehicle 105 can be configured to operate in a fully autonomous (e.g., self-driving) operating mode in which the vehicle 105 is controllable without user input (e.g., can drive and navigate with no input from a human operator present in the vehicle 105 and/or remote from the vehicle 105). The vehicle 105 can operate in a semi-autonomous operating mode in which the vehicle 105 can operate with some input from a human operator present in the vehicle 105 (and/or a human operator that is remote from the vehicle 105). The vehicle 105 can enter into a manual operating mode in which the vehicle 105 is fully controllable by a human operator (e.g., human driver, pilot, etc.) and can be prohibited and/or disabled (e.g., temporary, permanently, etc.) from performing autonomous navigation (e.g., autonomous driving, flying, etc.). The vehicle 105 can be configured to operate in other modes such as, for example, park and/or sleep modes (e.g., for use between tasks/actions such as waiting to provide a vehicle service, recharging, etc.). In some implementations, the vehicle 105 can implement vehicle operating assistance technology (e.g., collision mitigation system, power assist steering, etc.), for example, to help assist the human operator of the vehicle 105 (e.g., while in a manual mode, etc.).

To help maintain and switch between operating modes, the vehicle computing system 110 can store data indicative of the operating modes of the vehicle 105 in a memory onboard the vehicle 105. For example, the operating modes can be defined by an operating mode data structure (e.g., rule, list, table, etc.) that indicates one or more operating parameters for the vehicle 105, while in the particular operating mode. For example, an operating mode data structure can indicate that the vehicle 105 is to autonomously plan its motion when in the fully autonomous operating mode. The vehicle computing system 110 can access the memory when implementing an operating mode.

The operating mode of the vehicle 105 can be adjusted in a variety of manners. For example, the operating mode of the vehicle 105 can be selected remotely, off-board the vehicle 105. For example, a remote computing system (e.g., of a vehicle provider and/or service entity associated with the vehicle 105) can communicate data to the vehicle 105 instructing the vehicle 105 to enter into, exit from, maintain, etc. an operating mode. By way of example, such data can instruct the vehicle 105 to enter into the fully autonomous operating mode.

In some implementations, the operating mode of the vehicle 105 can be set onboard and/or near the vehicle 105. For example, the vehicle computing system 110 can automatically determine when and where the vehicle 105 is to enter, change, maintain, etc. a particular operating mode (e.g., without user input). Additionally, or alternatively, the operating mode of the vehicle 105 can be manually selected via one or more interfaces located onboard the vehicle 105 (e.g., key switch, button, etc.) and/or associated with a computing device proximate to the vehicle 105 (e.g., a tablet operated by authorized personnel located near the vehicle 105). In some implementations, the operating mode of the vehicle 105 can be adjusted by manipulating a series of interfaces in a particular order to cause the vehicle 105 to enter into a particular operating mode.

The vehicle computing system 110 can include one or more computing devices located onboard the vehicle 105. For example, the computing device(s) can be located on and/or within the vehicle 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the vehicle 105 (e.g., its computing system, one or more processors, etc.) to perform operations and functions, such as those described herein for controlling an autonomous vehicle, communicating with other computing systems, etc.

The vehicle 105 can include a communications system 115 configured to allow the vehicle computing system 110 (and its computing device(s)) to communicate with other computing devices. The communications system 115 can include any suitable components for interfacing with one or more network(s) 120, including, for example, transmitters, receivers, ports, controllers, antennas, and/or other suitable components that can help facilitate communication. In some implementations, the communications system 115 can include a plurality of components (e.g., antennas, transmitters, and/or receivers) that allow it to implement and utilize multiple-input, multiple-output (MIMO) technology and communication techniques.

The vehicle computing system 110 can use the communications system 115 to communicate with one or more computing device(s) that are remote from the vehicle 105 over one or more networks 120 (e.g., via one or more wireless signal connections). The network(s) 120 can exchange (send or receive) signals (e.g., electronic signals), data (e.g., data from a computing device), and/or other information and include any combination of various wired (e.g., twisted pair cable) and/or wireless communication mechanisms (e.g., cellular, wireless, satellite, microwave, and radio frequency) and/or any desired network topology (or topologies). For example, the network(s) 120 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communication network (or combination thereof) for transmitting data to and/or from the vehicle 105 and/or among computing systems.

In some implementations, the communications system 115 can also be configured to enable the vehicle 105 to communicate with and/or provide and/or receive data and/or signals from a remote computing device associated with a user 125 and/or an item (e.g., an item to be picked-up for a courier service). For example, the communications system 115 can allow the vehicle 105 to locate and/or exchange communications with a user device 130 of a user 125. In some implementations, the communications system 115 can allow communication among one or more of the system(s) on-board the vehicle 105.

As shown in FIG. 1, the vehicle 105 can include one or more sensors 135, an autonomy computing system 140, a vehicle controller 145, one or more vehicle control systems 150, and other systems, as described herein. One or more of these systems can be configured to communicate with one another via one or more communication channels. The communication channel(s) can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel(s).

The sensor(s) 135 can be configured to acquire sensor data 155. The sensor(s) 135 can be external sensors configured to acquire external sensor data. This can include sensor data associated with the surrounding environment of the vehicle 105. The surrounding environment of the vehicle 105 can include/be represented in the field of view of the sensor(s) 135. For instance, the sensor(s) 135 can acquire image and/or other data of the environment outside of the vehicle 105 and within a range and/or field of view of one or more of the sensor(s) 135. The sensor(s) 135 can include one or more Light Detection and Ranging (LIDAR) systems, one or more Radio Detection and Ranging (RADAR) systems, one or more cameras (e.g., visible spectrum cameras, infrared cameras, etc.), one or more motion sensors, one or more audio sensors (e.g., microphones, etc.), and/or other types of imaging capture devices and/or sensors. The one or more sensors can be located on various parts of the vehicle 105 including a front side, rear side, left side, right side, top, and/or bottom of the vehicle 105. The sensor data 155 can include image data (e.g., 2D camera data, video data, etc.), RADAR data, LIDAR data (e.g., 3D point cloud data, etc.), audio data, and/or other types of data. The vehicle 105 can also include other sensors configured to acquire data associated with the vehicle 105. For example, the vehicle 105 can include inertial measurement unit(s), wheel odometry devices, and/or other sensors.

In some implementations, the sensor(s) 135 can include one or more internal sensors. The internal sensor(s) can be configured to acquire sensor data 155 associated with the interior of the vehicle 105. For example, the internal sensor(s) can include one or more cameras, one or more infrared sensors, one or more motion sensors, one or more weight sensors (e.g., in a seat, in a trunk, etc.), and/or other types of sensors. The sensor data 155 acquired via the internal sensor(s) can include, for example, image data indicative of a position of a passenger or item located within the interior (e.g., cabin, trunk, etc.) of the vehicle 105. This information can be used, for example, to ensure the safety of the passenger, to prevent an item from being left by a passenger, confirm the cleanliness of the vehicle 105, remotely assist a passenger, etc.

In some implementations, the sensor data 155 can be indicative of one or more objects within the surrounding environment of the vehicle 105. The object(s) can include, for example, vehicles, pedestrians, bicycles, and/or other objects. The object(s) can be located in front of, to the rear of, to the side of, above, below the vehicle 105, etc. The sensor data 155 can be indicative of locations associated with the object(s) within the surrounding environment of the vehicle 105 at one or more times. The object(s) can be static objects (e.g., not in motion) and/or dynamic objects/actors (e.g., in motion or likely to be in motion) in the vehicle's environment. The sensor(s) 135 can provide the sensor data 155 to the autonomy computing system 140.

In addition to the sensor data 155, the autonomy computing system 140 can obtain map data 160. The map data 160 can provide detailed information about the surrounding environment of the vehicle 105 and/or the geographic area in which the vehicle was, is, and/or will be located. For example, the map data 160 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, and/or other traffic control devices); obstruction information (e.g., temporary or permanent blockages, etc.); event data (e.g., road closures/traffic rule alterations due to parades, concerts, sporting events, etc.); nominal vehicle path data (e.g., indicate of an ideal vehicle path such as along the center of a certain lane, etc.); and/or any other map data that provides information that assists the vehicle computing system 110 in processing, analyzing, and perceiving its surrounding environment and its relationship thereto. In some implementations, the map data 160 can include high definition map data. In some implementations, the map data 160 can include sparse map data indicative of a limited number of environmental features (e.g., lane boundaries, etc.). In some implementations, the map data can be limited to geographic area(s) and/or operating domains in which the vehicle 105 (or autonomous vehicles generally) may travel (e.g., due to legal/regulatory constraints, autonomy capabilities, and/or other factors).

The vehicle 105 can include a positioning system 165. The positioning system 165 can determine a current position of the vehicle 105. This can help the vehicle 105 localize itself within its environment. The positioning system 165 can be any device or circuitry for analyzing the position of the vehicle 105. For example, the positioning system 165 can determine position by using one or more of inertial sensors (e.g., inertial measurement unit(s), etc.), a satellite positioning system, based on IP address, by using triangulation and/or proximity to network access points or other network components (e.g., cellular towers, WIFI access points, etc.) and/or other suitable techniques. The position of the vehicle 105 can be used by various systems of the vehicle computing system 110 and/or provided to a remote computing system. For example, the map data 160 can provide the vehicle 105 relative positions of the elements of a surrounding environment of the vehicle 105. The vehicle 105 can identify its position within the surrounding environment (e.g., across six axes, etc.) based at least in part on the map data 160. For example, the vehicle computing system 110 can process the sensor data 155 (e.g., LIDAR data, camera data, etc.) to match it to a map of the surrounding environment to get an understanding of the vehicle's position within that environment. Data indicative of the vehicle's position can be stored, communicated to, and/or otherwise obtained by the autonomy computing system 140.

The autonomy computing system 140 can perform various functions for autonomously operating the vehicle 105. For example, the autonomy computing system 140 can perform the following functions: perception 170A, prediction 170B, and motion planning 170C. For example, the autonomy computing system 140 can obtain the sensor data 155 via the sensor(s) 135, process the sensor data 155 (and/or other data) to perceive its surrounding environment, predict the motion of objects within the surrounding environment, and generate an appropriate motion plan through such surrounding environment. In some implementations, these autonomy functions can be performed by one or more sub-systems such as, for example, a perception system, a prediction system, a motion planning system, and/or other systems that cooperate to perceive the surrounding environment of the vehicle 105 and determine a motion plan for controlling the motion of the vehicle 105 accordingly. In some implementations, one or more of the perception, prediction, and/or motion planning functions 170A, 170B, 170C can be performed by (and/or combined into) the same system and/or via shared computing resources. In some implementations, one or more of these functions can be performed via different sub-systems. As further described herein, the autonomy computing system 140 can communicate with the one or more vehicle control systems 150 to operate the vehicle 105 according to the motion plan (e.g., via the vehicle controller 145, etc.).

The vehicle computing system 110 (e.g., the autonomy computing system 140) can identify one or more objects within the surrounding environment of the vehicle 105 based at least in part on the sensor data 135 and/or the map data 160. The objects perceived within the surrounding environment can be those within the field of view of the sensor(s) 135 and/or predicted to be occluded from the sensor(s) 135. This can include object(s) not in motion or not predicted to move (static objects) and/or object(s) in motion or predicted to be in motion (dynamic objects/actors). The vehicle computing system 110 (e.g., performing the perception function 170C, using a perception system, etc.) can process the sensor data 155, the map data 160, etc. to obtain perception data 175A. The vehicle computing system 110 can generate perception data 175A that is indicative of one or more states (e.g., current and/or past state(s)) of one or more objects that are within a surrounding environment of the vehicle 105. For example, the perception data 175A for each object can describe (e.g., for a given time, time period) an estimate of the object's: current and/or past location (also referred to as position); current and/or past speed/velocity; current and/or past acceleration; current and/or past heading; current and/or past orientation; size/footprint (e.g., as represented by a bounding shape, object highlighting, etc.); class (e.g., pedestrian class vs. vehicle class vs. bicycle class, etc.), the uncertainties associated therewith, and/or other state information. The vehicle computing system 110 can utilize one or more algorithms and/or machine-learned model(s) that are configured to identify object(s) based at least in part on the sensor data 155. This can include, for example, one or more neural networks trained to identify object(s) within the surrounding environment of the vehicle 105 and the state data associated therewith. The perception data 175A can be utilized for the prediction function 170B of the autonomy computing system 140.

The vehicle computing system 110 can be configured to predict a motion of the object(s) within the surrounding environment of the vehicle 105. For instance, the vehicle computing system 110 can generate prediction data 175B associated with such object(s). The prediction data 175B can be indicative of one or more predicted future locations of each respective object. For example, the prediction system 175B can determine a predicted motion trajectory along which a respective object is predicted to travel over time. A predicted motion trajectory can be indicative of a path that the object is predicted to traverse and an associated timing with which the object is predicted to travel along the path. The predicted path can include and/or be made up of a plurality of way points. In some implementations, the prediction data 175B can be indicative of the speed and/or acceleration at which the respective object is predicted to travel along its associated predicted motion trajectory. The vehicle computing system 110 can utilize one or more algorithms and/or machine-learned model(s) that are configured to predict the future motion of object(s) based at least in part on the sensor data 155, the perception data 175A, map data 160, and/or other data. This can include, for example, one or more neural networks trained to predict the motion of the object(s) within the surrounding environment of the vehicle 105 based at least in part on the past and/or current state(s) of those objects as well as the environment in which the objects are located (e.g., the lane boundary in which it is travelling, etc.). The prediction data 175B can be utilized for the motion planning function 170C of the autonomy computing system 140.

The vehicle computing system 110 can determine a motion plan for the vehicle 105 based at least in part on the perception data 175A, the prediction data 175B, and/or other data. For example, the vehicle computing system 110 can generate motion planning data 175C indicative of a motion plan. The motion plan can include vehicle actions (e.g., speed(s), acceleration(s), other actions, etc.) with respect to one or more of the objects within the surrounding environment of the vehicle 105 as well as the objects' predicted movements. The motion plan can include one or more vehicle motion trajectories that indicate a path for the vehicle 105 to follow. A vehicle motion trajectory can be of a certain length and/or time range. A vehicle motion trajectory can be defined by one or more waypoints (with associated coordinates). The planned vehicle motion trajectories can indicate the path the vehicle 105 is to follow as it traverses a route from one location to another. Thus, the vehicle computing system 110 can take into account a route/route data when performing the motion planning function 170C.

The motion planning system 170C can implement an optimization algorithm, machine-learned model, etc. that considers cost data associated with a vehicle action as well as other objective functions (e.g., cost functions based on speed limits, traffic lights, etc.), if any, to determine optimized variables that make up the motion plan. The vehicle computing system 110 can determine that the vehicle 105 can perform a certain action (e.g., pass an object, etc.) without increasing the potential risk to the vehicle 105 and/or violating any traffic laws (e.g., speed limits, lane boundaries, signage, etc.). For instance, the vehicle computing system 110 can evaluate the predicted motion trajectories of one or more objects during its cost data analysis to help determine an optimized vehicle trajectory through the surrounding environment. The motion planning system 170C can generate cost data associated with such trajectories. In some implementations, one or more of the predicted motion trajectories and/or perceived objects may not ultimately change the motion of the vehicle 105 (e.g., due to an overriding factor). In some implementations, the motion plan may define the vehicle's motion such that the vehicle 105 avoids the object(s), reduces speed to give more leeway to one or more of the object(s), proceeds cautiously, performs a stopping action, passes an object, queues behind/in front of an object, etc.

The vehicle computing system 110 can be configured to continuously update the vehicle's motion plan and a corresponding planned vehicle motion trajectory. For example, in some implementations, the vehicle computing system 110 can generate new motion planning data 175C/motion plan(s) for the vehicle 105 (e.g., multiple times per second, etc.). Each new motion plan can describe a motion of the vehicle 105 over the next planning period (e.g., next several seconds, etc.). Moreover, a new motion plan may include a new planned vehicle motion trajectory. Thus, in some implementations, the vehicle computing system 110 can continuously operate to revise or otherwise generate a short-term motion plan based on the currently available data. Once the optimization planner has identified the optimal motion plan (or some other iterative break occurs), the optimal motion plan (and the planned motion trajectory) can be selected and executed by the vehicle 105.

The vehicle computing system 110 can cause the vehicle 105 to initiate a motion control in accordance with at least a portion of the motion planning data 175C. A motion control can be an operation, action, etc. that is associated with controlling the motion of the vehicle 105. For instance, the motion planning data 175C can be provided to the vehicle control system(s) 150 of the vehicle 105. The vehicle control system(s) 150 can be associated with a vehicle controller 145 that is configured to implement a motion plan. The vehicle controller 145 can serve as an interface/conduit between the autonomy computing system 140 and the vehicle control systems 150 of the vehicle 105 and any electrical/mechanical controllers associated therewith. The vehicle controller 145 can, for example, translate a motion plan into instructions for the appropriate vehicle control component (e.g., acceleration control, brake control, steering control, etc.). By way of example, the vehicle controller 145 can translate a determined motion plan into instructions to adjust the steering of the vehicle 105 “X” degrees, apply a certain magnitude of braking force, increase/decrease speed, etc. The vehicle controller 145 can help facilitate the responsible vehicle control (e.g., braking control system, steering control system, acceleration control system, etc.) to execute the instructions and implement a motion plan (e.g., by sending control signal(s), making the translated plan available, etc.). This can allow the vehicle 105 to autonomously travel within the vehicle's surrounding environment.

The vehicle computing system 110 can store other types of data. For example, an indication, record, and/or other data indicative of the state of the vehicle (e.g., its location, motion trajectory, health information, etc.), the state of one or more users (e.g., passengers, operators, etc.) of the vehicle, and/or the state of an environment including one or more objects (e.g., the physical dimensions and/or appearance of the one or more objects, locations, predicted motion, etc.) can be stored locally in one or more memory devices of the vehicle 105. Additionally, the vehicle 105 can communicate data indicative of the state of the vehicle, the state of one or more passengers of the vehicle, and/or the state of an environment to a computing system that is remote from the vehicle 105, which can store such information in one or more memories remote from the vehicle 105. Moreover, the vehicle 105 can provide any of the data created and/or store onboard the vehicle 105 to another vehicle.

The vehicle computing system 110 can include the one or more vehicle user devices 180. For example, the vehicle computing system 110 can include one or more user devices with one or more display devices located onboard the vehicle 15. A display device (e.g., screen of a tablet, laptop, and/or smartphone) can be viewable by a user of the vehicle 105 that is located in the front of the vehicle 105 (e.g., driver's seat, front passenger seat). Additionally, or alternatively, a display device can be viewable by a user of the vehicle 105 that is located in the rear of the vehicle 105 (e.g., a back-passenger seat). The user device(s) associated with the display devices can be any type of user device such as, for example, a table, mobile phone, laptop, etc. The vehicle user device(s) 180 can be configured to function as human-machine interfaces. For example, the vehicle user device(s) 180 can be configured to obtain user input, which can then be utilized by the vehicle computing system 110 and/or another computing system (e.g., a remote computing system, etc.). For example, a user (e.g., a passenger for transportation service, a vehicle operator, etc.) of vehicle 105 can provide user input to adjust a destination location of vehicle 105. The vehicle computing system 110 and/or another computing system can update the destination location of the vehicle 105 and the route associated therewith to reflect the change indicated by the user input.

The vehicle 105 can be configured to perform vehicle services for one or a plurality of different service entities 185. A vehicle 105 can perform a vehicle service by, for example and as further described herein, travelling (e.g., traveling autonomously) to a location associated with a requested vehicle service, allowing user(s) and/or item(s) to board or otherwise enter the vehicle 105, transporting the user(s) and/or item(s), allowing the user(s) and/or item(s) to deboard or otherwise exit the vehicle 105, etc. In this way, the vehicle 105 can provide the vehicle service(s) for a service entity to a user.

A service entity 185 can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of one or more vehicle services to one or more users. For example, a service entity can offer vehicle service(s) to users via one or more software applications (e.g., that are downloaded onto a user computing device), via a website, and/or via other types of interfaces that allow a user to request a vehicle service. As described herein, the vehicle services can include transportation services (e.g., by which a vehicle transports user(s) from one location to another), delivery services (e.g., by which a vehicle transports/delivers item(s) to a requested destination location), courier services (e.g., by which a vehicle retrieves item(s) from a requested origin location and transports/delivers the item to a requested destination location), and/or other types of services. The vehicle services can be wholly performed by the vehicle 105 (e.g., travelling from the user/item origin to the ultimate destination, etc.) or performed by one or more vehicles and/or modes of transportation (e.g., transferring the user/item at intermediate transfer points, etc.).

An operations computing system 190A of the service entity 185 can help to coordinate the performance of vehicle services by autonomous vehicles. The operations computing system 190A can include and/or implement one or more service platforms of the service entity. The operations computing system 190A can include one or more computing devices. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the operations computing system 190A (e.g., it's one or more processors, etc.) to perform operations and functions, such as those described herein matching users and vehicles/vehicle fleets, deploying vehicles, facilitating the provision of vehicle services via autonomous vehicles, etc.

A user 125 can request a vehicle service from a service entity 185. For example, the user 125 can provide user input to a user device 130 to request a vehicle service (e.g., via a user interface associated with a mobile software application of the service entity 185 running on the user device 130). The user device 130 can communicate data indicative of a vehicle service request 195 to the operations computing system 190A associated with the service entity 185 (and/or another associated computing system that can then communicate data to the operations computing system 190A). The vehicle service request 195 can be associated with a user. The associated user can be the one that submits the vehicle service request (e.g., via an application on the user device 130). In some implementations, the user may not be the user that submits the vehicle service request. The vehicle service request can be indicative of the user. For example, the vehicle service request can include an identifier associated with the user and/or the user's profile/account with the service entity 185. The vehicle service request 195 can be generated in a manner that avoids the use of personally identifiable information and/or allows the user to control the types of information included in the vehicle service request 195. The vehicle service request 195 can also be generated, communicated, stored, etc. in a secure manner to protect information.

The vehicle service request 195 can indicate various types of information. For example, the vehicle service request 194 can indicate the type of vehicle service that is desired (e.g., a transportation service, a delivery service, a courier service, etc.), one or more locations (e.g., an origin location, a destination location, etc.), timing constraints (e.g., pick-up time, drop-off time, deadlines, etc.), and/or geographic constraints (e.g., to stay within a certain area, etc.). The service request 195 can indicate a type/size/class of vehicle such as, for example, a sedan, an SUV, luxury vehicle, standard vehicle, etc. The vehicle service request 195 can indicate a product of the service entity 185. For example, the vehicle service request 195 can indicate that the user is requesting a transportation pool product by which the user would potentially share the vehicle (and costs) with other users/items. In some implementations, the vehicle service request 195 can explicitly request for the vehicle service to be provided by an autonomous vehicle or a human-driven vehicle. In some implementations, the vehicle service request 195 can indicate a number of users that will be riding in the vehicle/utilizing the vehicle service. In some implementations, the vehicle service request 195 can indicate preferences/special accommodations of an associated user (e.g., music preferences, climate preferences, wheelchair accessibility, etc.) and/or other information.

The operations computing system 190A of the service entity 185 can process the data indicative of the vehicle service request 195 and generate a vehicle service assignment that is associated with the vehicle service request. The operations computing system can identify one or more vehicles that may be able to perform the requested vehicle services to the user 125. The operations computing system 190A can identify which modes of transportation are available to a user for the requested vehicle service (e.g., light electric vehicles, human-drive vehicles, autonomous vehicles, aerial vehicle, etc.) and/or the number of transportation modes/legs of a potential itinerary of the user for completing the vehicle service (e.g., single or plurality of modes, single or plurality of legs, etc.). For example, the operations computing system 190A can determined which autonomous vehicle(s) are online with the service entity 185 (e.g., available for a vehicle service assignment, addressing a vehicle service assignment, etc.) to help identify which autonomous vehicle(s) would be able to provide the vehicle service.

The operations computing system 190A and/or the vehicle computing system 110 can communicate with one or more other computing systems 190B that are remote from the vehicle 105. This can include, for example, computing systems associated with government functions (e.g., emergency services, regulatory bodies, etc.), computing systems associated with vehicle providers other than the service entity, computing systems of other vehicles (e.g., other autonomous vehicles, aerial vehicles, etc.). Communication with the other computing systems 190B can occur via the network(s) 120.

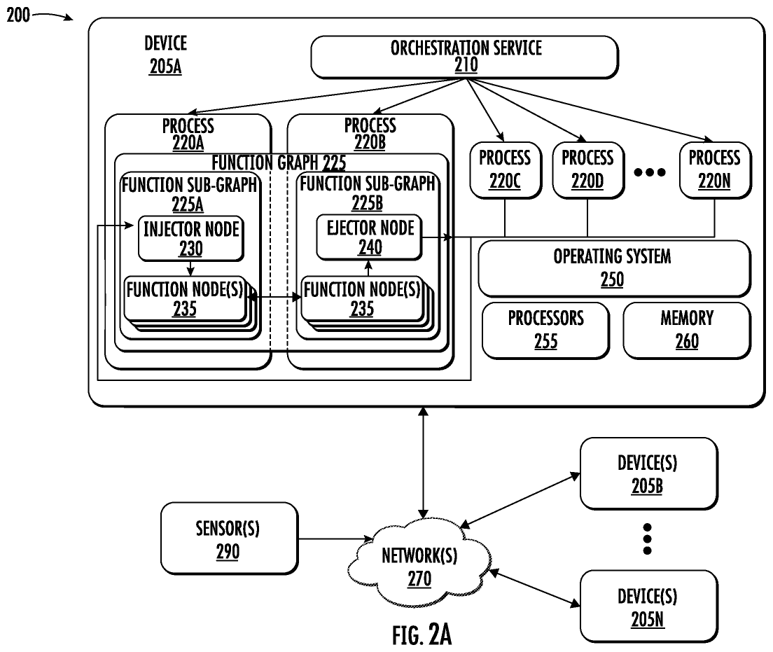

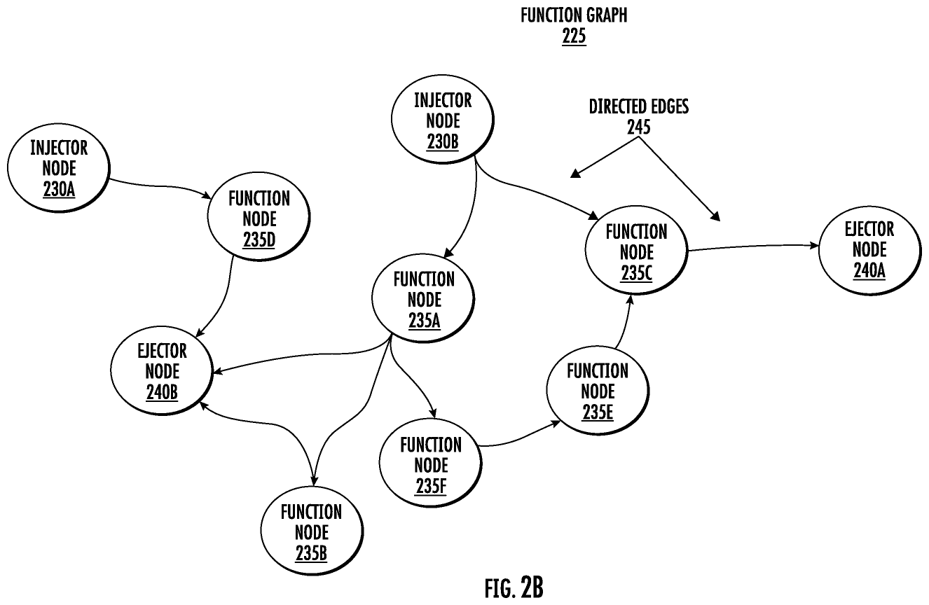

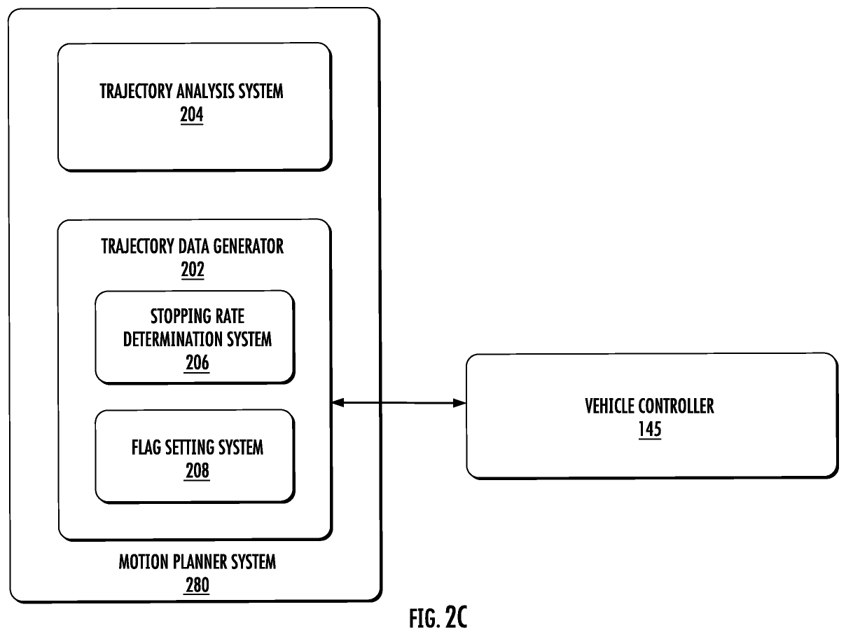

FIG. 2A depicts a diagram of an example computing system 200 including one or more of the plurality of devices (e.g., plurality of devices 205A-N) of the computing system of the present disclosure. The plurality of devices 205A-N can include one or more devices configured to communicate over one or more wired and/or wireless communication channels (e.g., wired and/or wireless networks). Each device (e.g., 205A) can be associated with a type, an operating system 250, and/or one or more designated tasks. A type, for example, can include an indication of the one or more designated tasks of a respective device 205A. The one or more designated tasks, for example, can include performing one or more processes 220A-N and/or services of the computing system 200.

Each device 205A of the plurality of devices 205A-N can include and/or have access to one or more processors 255 and/or one or more memories 260 (e.g., RAM memory, ROM memory, cache memory, flash memory, etc.). The one or more memories 260 can include one or more tangible non-transitory computer readable instructions that, when executed by the one or more processors 255, cause the device 205A to perform one or more operations. The operations can include, for example, executing one or more of a plurality of processes of the computing system 200. For instance, each device 205A can include a compute node configured to run one or more processes 220A-N of the plurality of processes.

For example, the device 205A can include an orchestration service 210. The orchestration service 210 can include a start-up process of the device 205A. The orchestration service 210, for example, can include an operating system service (e.g., a service running as part of the operating system 250). In addition, or alternatively, the orchestration service can include a gRPC service. The device 205A can run the orchestration service 210 to configure and start processes 220A-220N of the device 205A. In some implementations, the orchestration service 210 can include a primary orchestrator and/or at least one of a plurality of secondary orchestrators. For example, each respective device of the plurality of devices can include at least one of the plurality of secondary orchestrators. The primary orchestrator can be configured to receive global configuration data and provide the global configuration data to the plurality of secondary orchestrators. The global configuration data, for example, can include one or more instructions indicative of the one or more designated tasks for each respective device(s) 205A-N, a software version and/or environment on which to run a plurality of processes (e.g., 220A-220N of the device 205A) of the computing system 200, etc. A secondary orchestrator for each respective device can receive the global configuration data and configure and start one or more processes at the respective device based on the global configuration data.

For instance, each process (e.g., process 220A, 220B) can include a plurality of function nodes 235 (e.g., pure functions) connected by one or more directed edges that dictate the flow of data between the plurality of function nodes 235. Each device 205A can execute (e.g., via one or more processors, etc.) a respective plurality of function nodes 235 to run a respective process 220A, 220B. For example, the plurality of function nodes 235 can be arranged in one or more function graphs 225. A function graph 225 can include a plurality of (e.g., series of) function nodes 235 arranged (e.g., by one or more directed edges) in a pipeline, graph architecture, etc.

For example, with reference to FIG. 2B, FIG. 2B depicts a diagram of an example functional graph 225 according to example implementations of the present disclosure. The function graph 225 can include a plurality of function nodes 235A-F, one or more injector nodes 230A-B, one or more ejector nodes 240A-B, and/or one or more directed edges 245. The function nodes 235 can include one or more computing functions with one or more inputs (e.g., of one or more data types) and one or more outputs (e.g., of one or more data types). For example, the function nodes 235A-F can be implemented such that they define one or more accepted inputs and one or more outputs. In some implementations, each function node 235A-F can be configured to obtain one or more inputs of a single data type, perform one or more functions on the one or more inputs, and output one or more outputs of a single data type.

Each function node of the plurality of function nodes 235A-F can be arranged in a directed graph architecture (e.g., including a plurality of function graphs) and can be configured to obtain function input data associated with an autonomous vehicle based on the one or more directed edges 245 (e.g., of the directed graph 225). For instance, the function nodes 235A-F can be connected by one or more directed edges 245 of the function graph 225 (and/or a subgraph 225A, 225B of the function graph 225 with reference to FIG. 2A). The one or more directed edges 245 can dictate how data flows through the function graph 225 (and/or the subgraphs 225A, 225B of FIG. 2A). For example, the one or more directed edges 245 can be formed based on the defined inputs and outputs of each of the function nodes 235A-F of the function graph 225. The function nodes 235A-F can generate function output data based on the function input data. For instance, the function nodes 235A-F can perform one or more functions of the autonomous vehicle on the function input data to obtain the function output data. The function nodes 235A-F can communicate the function output data to one or more other function nodes of the plurality of function nodes 235A-F based on the one or more directed edges 245 of the directed graph 225.

In addition, or alternatively, each function graph 225 can include one or more injector nodes 230A-B and one or more ejector nodes 220A-B configured to communicate with one or more remote devices and/or processes (e.g., processes 220C-220N of FIG. 2A) outside the function graph 225. The injector nodes 230A-B, for example, can be configured to communicate with one or more devices and/or processes (e.g., processes 220C-220N of FIG. 2A) outside the function graph 225 to obtain input data for the function graph 225. By way of example, each of the one or more injector nodes 230A-B can include a function configured to obtain and/or process sensor data from a respective sensor 280 shown in FIG. 2A (e.g., sensor(s) 135 of FIG. 1). The ejector nodes 240A-B can be configured to communicate with one or more devices 205B-N and/or processes 220C-220N outside the function graph 225 to provide function output data of the function graph 225 to the one or more devices 205B-N and/or processes 220C-220N.

Turning back to FIG. 2A, each device 205A-N can be configured to execute one or more function graphs 225 to run one or more processes 220A, 220B of the plurality of processes 220A-N of the respective device 205A. For example, as described herein, each respective device can be configured to run a respective set of processes based on global configuration data. Each process 220A-N can include an executed instance of a function graph and/or a subgraph of a function graph. For example, in some implementations, a function graph 225 can be separated across multiple processes 220A, 220B. Each process 220A, 220B can include a subgraph 225A, 225B (e.g., process 220A including subgraph 225A, process 220B including subgraph 225B, etc.) of the function graph 225. In such a case, each process 220A, 220B of the function graph 225 can be communicatively connected by one or more function nodes 235 of the function graph 225. In this manner, each respective device 205A-N can be configured to run a respective process by executing a respective function graph and/or a subgraph of the respective function graph. Thus, each function graph can be implemented as a single process or multiple processes. For instance, the messages communicated between nodes of a sub-graph dedicated to motion planning for an autonomous vehicle can help identify a nominal path for the vehicle given the area/environment in which the vehicle is operating, motion constraints (e.g., braking constraints, etc.), costs, vehicle trajectories, etc. and plan the motion of the autonomous vehicle accordingly.

In some implementations, one or more of the plurality of processes 220A-N can include containerized services (application containers, etc.). For instance, each process 220A-N can be implemented as a container (e.g., docker containers, etc.). For example, the plurality of processes 220A-N can include one or more containerized processes abstracted away from an operating system 250 associated with each respective device 205A. As an example, the containerized processes can be run in docker containers, such that each process is run and authorized in isolation. For example, each respective container can include one or more designated computing resources (e.g., processing power, memory locations, etc.) devoted to processes configured to run within the respective container. Moreover, in some implementations, each container can include an isolated runtime configuration (e.g., software model, etc.). In this manner, each container can independently run processes within a container specific runtime environment.

The plurality of devices 205A-N, sensors 290, processes 220A-N, etc. of the computing system 200 (e.g., the plurality of processes of the vehicle computing system 110, a plurality of processes of the one or more remote devices, etc.) can be communicatively connected over one or more wireless and/or wired networks 270. For instance, the plurality of devices 205A-N (and/or processes 220A-N of device 205A) can communicate over one or more communication channels (e.g., networks 270). Each device and/or process can exchange messages over the one or more communicative channels using a message interchange format (e.g., JSON, IDL, etc.). By way of example, a respective process can utilize one or more communication protocols (e.g., HTTP, REST, gRPC, etc.) to provide and/or receive messages from one or more respective device processes (e.g., other processes running on the same device) and/or remote processes (e.g., processes running on one or more other devices of the computing system). In this manner, devices can be configured to communicate messages between one or more devices, services, and/or other processes to carry out one or more tasks. The messages, for example, can include function output data associated with a respective function node (e.g., 235).

FIG. 2C depicts a block diagram of an example motion planner system 280 according to example embodiments of the present disclosure. The functionality of this system can be implemented via a function graph, as described herein. To ensure that the autonomous vehicle (e.g., autonomous vehicle 105 in FIG. 1) can stop appropriately, the autonomous vehicle (e.g., autonomous vehicle 105 in FIG. 1) can include a motion planner system 280 that determines a stopping rate for a particular trajectory and transmits the trajectory data to a vehicle controller 145. The motion planner 280 can include a trajectory analysis system 204 and a trajectory data generator 202.

The trajectory analysis system 204 can access position data for one or more obstacles and map data (e.g., map data 160 in FIG. 1) for an environment around the autonomous vehicle (e.g., autonomous vehicle 105 in FIG. 1). Position data for one or more obstacles can be accessed from the perception data (e.g., perception data 175A in FIG. 1) produced by the perception function (e.g., see perception function 170A of FIG. 1) and/or the prediction data (e.g., prediction data 175B of FIG. 1) produced by the prediction function (e.g., prediction function 170B of FIG. 1) of the vehicle computing system (e.g., vehicle computing system 110 in FIG. 1). For example, the perception data (e.g., perception data 175A in FIG. 1) can include the location and position of one or more objects in the environment around the autonomous vehicle (e.g., autonomous vehicle 105 in FIG. 1). The prediction data (e.g., prediction data 175B in FIG. 1) can include data describing the possible movement of any detected objects in the future.

Based on this information, the trajectory analysis system 204 can generate one or more candidate trajectories. Candidate trajectories can be generated by the motion planning function (e.g., motion planning function 170C of FIG. 1) of the vehicle computing system (e.g., vehicle computing system 110 in FIG. 1) by determining a future point along a nominal path as the target point. The vehicle computing system (e.g., vehicle computing system 110 in FIG. 1) can, via the motion planning function (e.g., motion planning function 170C of FIG. 1) generate a plurality of candidate trajectories from the current position of the autonomous vehicle (e.g., autonomous vehicle 105 in FIG. 1) and the target point. In some examples, one candidate trajectory can represent the shortest path between the current position of the autonomous vehicle (e.g., autonomous vehicle 105 in FIG. 1) and the target point while retaining the current speed of the autonomous vehicle (e.g., autonomous vehicle 105 in FIG. 1). Other candidate trajectories can be generated by generating alternate speed profiles and laterally varying the path from the shortest path. Each of the candidate trajectories can be evaluated based on a cost associated with performing each trajectory. A particular trajectory can be selected as having the lowest cost.

A trajectory data generator 202 can generate trajectory data to be sent to the vehicle controller 145. The trajectory data generator 202 can include a stopping rate determination system 206 and a flag setting system 208. The stopping rate determination system 206 can determine, based on the selected trajectory, a target stopping rate that represents how quickly the autonomous vehicle (e.g., autonomous vehicle 105 in FIG. 1) must slow down to safely avoid a collision. To calculate the stopping rate, the stopping rate determination system 206 can determine the current velocity of the autonomous vehicle (e.g., autonomous vehicle 105 in FIG. 1), the target velocity of the autonomous vehicle (e.g., autonomous vehicle 105 in FIG. 1), and the distance available to reach the target velocity. For example, a vehicle can be determined to be in the path of the autonomous vehicle (e.g., autonomous vehicle 105 in FIG. 1) and is 80 meters in front of the autonomous vehicle (e.g., autonomous vehicle 105 in FIG. 1) travelling 30 m/s. Using 30 m/s as the current velocity of the autonomous vehicle (e.g., autonomous vehicle 105 in FIG. 1), 0 m/s as the target velocity of the autonomous vehicle (e.g., autonomous vehicle 105 in FIG. 1), and 60 meters as the distance available to reach the target velocity (e.g., leaving a 20 meter buffer distance between the autonomous vehicle and the vehicle, the stopping rate determination system 206 can determine that the autonomous vehicle (e.g., autonomous vehicle 105 in FIG. 1) average target stopping rate is 7.5 m/s².

In some examples, the target velocity may not be zero. For example, if a vehicle 30 meters in front of the autonomous vehicle slows from 30 m/s to 25 m/s, the autonomous vehicle (e.g., autonomous vehicle 105 in FIG. 1) can determine that it's current velocity is 30 m/s, it's target velocity is 20 m/s, and has 60 meters of distance to reach the target velocity (leaving a buffer distance of 20 meters). In this case, the average target stopping rate can be about 2.3 m/s². Also note that in this example, the other vehicle is also moving, allowing for additional distance in which to reduce velocity. Thus, the stopping rate is higher when the current velocity is higher, the target velocity is lower, and the distance available to reduce the velocity is shorter. Similarly, the target stopping rate is lower in situations when the current velocity is relatively, the target velocity is relatively high, and the distance available to stop is longer.

Thus, the selected trajectory can include a high stopping rate in response to an obstacle in the path of the autonomous vehicle (e.g., autonomous vehicle 105 in FIG. 1) that is very close (e.g., the distance available to stop is very short). In should be noted that is some examples, the vehicle computing system (e.g., vehicle computing system 110 in FIG. 1) can consider other alternatives, such as selecting an alternate path that avoids the obstacle (e.g., veering the autonomous vehicle (e.g., autonomous vehicle 105 in FIG. 1) such that it doesn't impact the obstacle. However, such alternatives are outside the scope of this disclosure and that are not discussed in detail. This disclosure chiefly discusses candidate trajectories in which stopping has been selected.

The stopping rate determination system 206 can determine whether the target stopping rate exceeds a threshold stopping rate. The threshold stopping rate can be a conservatively estimated stopping rate that can be achieved reliably and consistently by the autonomous vehicle. For example, a conservatively estimated stopping rate can be a rate that is lower than the maximum theoretical stopping rate of the autonomous vehicle (e.g., autonomous vehicle 105 in FIG. 1). For example, if the calculated theoretical stopping rate for an autonomous vehicle is 5 m/s², the autonomous vehicle (e.g., autonomous vehicle 105 in FIG. 1) may not always be able to stop at the rate. Instead, the actual measured stopping rate that the autonomous vehicle (e.g., autonomous vehicle 105 in FIG. 1) can reliably reach is 3.5 m/s². As a result, the autonomous vehicle (e.g., autonomous vehicle 105 in FIG. 1) can establish 3.5 m/s² as a threshold stopping rate that the autonomous vehicle (e.g., autonomous vehicle 105 in FIG. 1) can consistently meet. The threshold stopping rate can be stored in an accessible memory onboard the autonomous vehicle (e.g., autonomous vehicle 105 in FIG. 1) and can be updated and/or modified over time based on values detected by the autonomous vehicle (e.g., autonomous vehicle 105 in FIG. 1) or supplied to the autonomous vehicle (e.g., autonomous vehicle 105 in FIG. 1) through hardware and/or software updates.

The flag setting system 208 can, based on a determination whether the target stopping rate exceeds the first stopping rate, set an emergency braking flag included in the trajectory data that is sent to the vehicle controller 145. Trajectory data that is sent to the vehicle controller 145 can include fields indicating how the autonomous vehicle (e.g., autonomous vehicle 105 in FIG. 1) should be controlled including acceleration, braking, steering, etc. Included in the trajectory data can be a field for the emergency braking flag. When the emergency braking flag is set, this field can be set to true (e.g., setting Boolean value to true, setting a bit to 1, e.g.,). The value stored in this field can be accessed by the vehicle controller 145 to determine whether the emergency braking flag is set to true or not.

FIG. 3 depicts an example of a vehicle controller 145 according to example embodiments of the present disclosure. The vehicle controller 145 can include a flag analysis system 212, a mode determination system 214, and a braking command system 216. The flag analysis system 212 can, among other things, determine whether the emergency braking flag is set to true. The mode determination system 214 can set the braking mode of the autonomous vehicle (e.g., autonomous vehicle 105 in FIG. 1) based on whether or not the emergency braking flag is set to true. The mode determination system 214 can set the braking mode of the autonomous vehicle (e.g., autonomous vehicle 105 in FIG. 1) to the first braking mode 302 if the emergency braking flag is set to false. The first braking mode 302 can be associated with the normal operation of the autonomous vehicle (e.g., autonomous vehicle 105 in FIG. 1). While in the first braking mode 302, the maximum stopping rate is a conservatively estimated stopping rate.

In addition, while in the first braking mode 302, the vehicle controller 145 can implement longitudinal feedback control. Longitudinal feedback control can include measuring the longitudinal progress of the autonomous vehicle (e.g., how far the autonomous vehicle (e.g., autonomous vehicle 105 in FIG. 1) moves in a forward direction). The current position of the autonomous vehicle can be determined based on a satellite-based location determination system such as the global positioning system (e.g., GPS) or by other means, such as dead reckoning (in which a position of a vehicle is determined based the former position and an estimation of the direction and degree of movement since the vehicle was located at the former position). In this way, if the longitudinal progress of the autonomous vehicle (e.g., autonomous vehicle 105 in FIG. 1) is greater than or less than the projected distance, the vehicle controller 145 can adjust one or more braking commands to ensure that the autonomous vehicle (e.g., autonomous vehicle 105 in FIG. 1) meets the targeted stopping rate.

In addition, while in the first braking mode 302 the vehicle controller 145 can measure the current velocity of the autonomous vehicle (e.g., autonomous vehicle 105 in FIG. 1) and determine whether the current velocity has diverged from the targeted velocity. This information can be used to correct the commands/control signals to ensure that the planned velocity and the actual velocity match.

The mode determination system 214 can set the braking mode to a second braking mode if the emergency braking flag is set to true. In some examples, the current braking mode can be based on a value stored in memory accessible to the vehicle controller 145. Thus, setting the braking mode to a second braking mode can include accessing the memory storing the value representing the current braking mode and changing it from a value representing the first braking mode to a value representing the second braking mode. The second braking mode can be an emergency braking mode. While in the second braking mode the mode determination system 214 can disable longitudinal feedback control and discard any error tracking. While in the second braking mode 304 the braking system attempts to stop the autonomous vehicle (e.g., autonomous vehicle 105 in FIG. 1) as quickly as possible.

Once the mode determination system 214 determines the appropriate braking mode, the braking command system 216 can generate one or more braking command signals for controlling the stopping rate of the vehicle. The first braking mode 302 can be associated with a first maximum stopping value (e.g., the conservatively estimated stopping value). In some examples, while in the first mode 302, the stopping rate is less than the theoretical maximum stopping rate. The second braking mode 304 can be associated with a second maximum stopping rate. In some examples, the second maximum stopping rate can be the theoretical stopping rate of the autonomous vehicle. The association of braking modes and stopping rates can be stored in an accessible databased onboard the autonomous vehicle so that the motion planner system and/or vehicle controller can access this information.

The braking command system 216 can select a particular stopping rate (e.g., for the particular mode) and generate command signal(s) to achieve the stopping rate. For instance, the command signal(s) can be provided to a brake control system of the autonomous vehicle (e.g., autonomous vehicle 105 in FIG. 1) that can control the autonomous vehicle's (e.g., autonomous vehicle 105 in FIG. 1) brakes based at least in part on the command signal(s). The command signal(s) can include, for example, signals that cause the autonomous vehicle (e.g., autonomous vehicle 105 in FIG. 1) to activate one or more braking mechanisms and/or stop any acceleration mechanisms. The braking command signals can include data that controls the degree and duration at which the braking mechanism is activated.

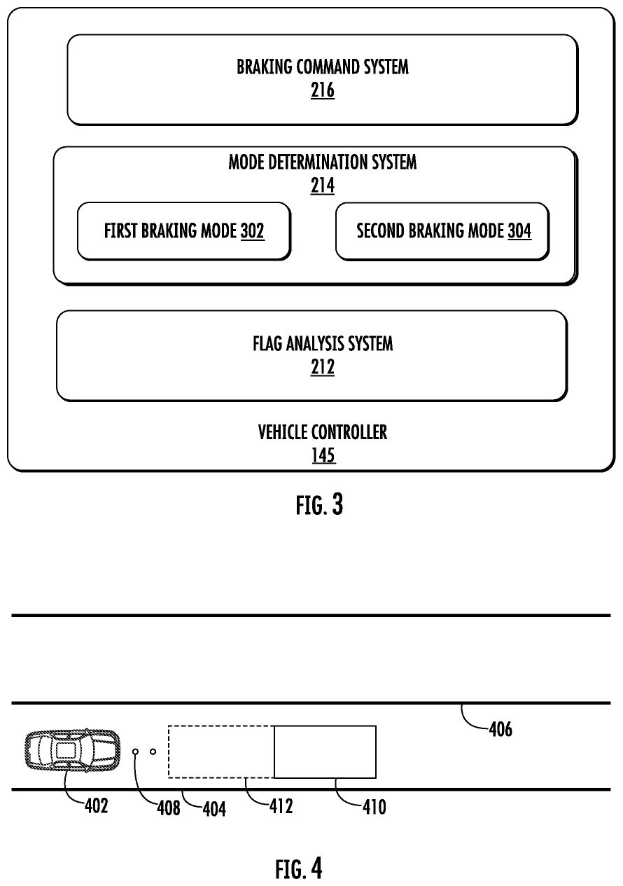

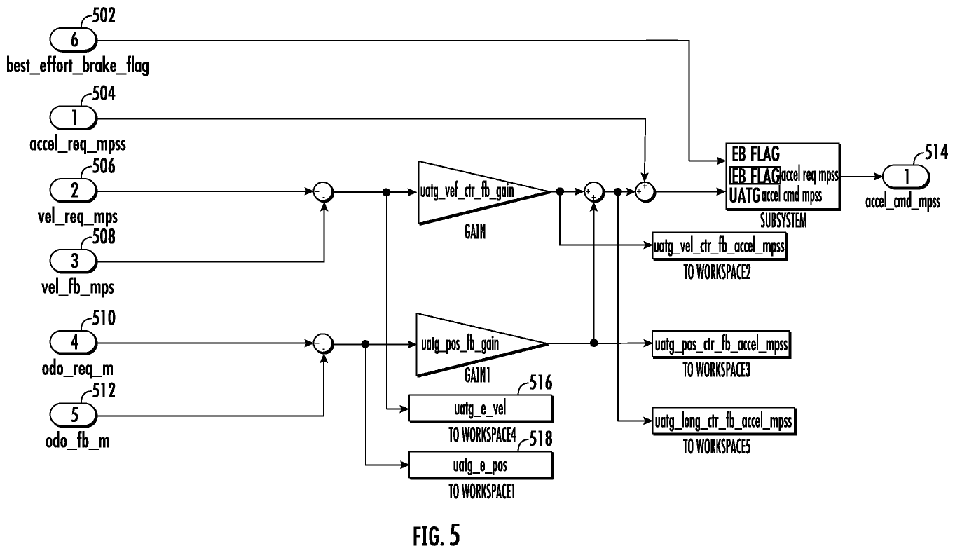

FIG. 4 depicts an example motion planning scenario 400 according to example embodiments of the present disclosure. In this example, an autonomous vehicle 402 is travelling between two lane boundaries (404, 406). The autonomous vehicle 402 can be generating a motion plan that describes travelling along a series of points (408). In this example, the autonomous vehicle 402 detects an obstacle 410 (e.g., another vehicle or other obstacle) in front of the autonomous vehicle 402. The autonomous vehicle 402 can determine an estimated stopping rate to prevent the autonomous vehicle 402 from entering buffer zone 412 between the autonomous vehicle 402 and the obstacle 410. If the estimated stopping rate exceeds as threshold value, the autonomous vehicle 402 can set an emergency braking flag included in trajectory data transmitted from a vehicle computing system (e.g., vehicle computing system 110 in FIG. 1) to a vehicle controller (e.g., vehicle controller 145 in FIG. 1).

For example, a vehicle computing system (e.g., vehicle computing system 110 in FIG. 1) can detect an obstacle 410 in the path of the autonomous vehicle (e.g., autonomous vehicle 105 in FIG. 1). The vehicle computing system (e.g., vehicle computing system 110 in FIG. 1) can determine the current speed of the autonomous vehicle (e.g., vehicle computing system 110 in FIG. 1) and the distance in which the autonomous vehicle needs to stop. In this example, the autonomous vehicle is currently travelling at 20 m/s and has 40 meters to stop before entering a 20 meter buffer zone 412 adjacent to the obstacle. The vehicle computing system (e.g., vehicle computing system 110 in FIG. 1) can determine that the target stopping rate is 5 m/s². The vehicle computing system (e.g., vehicle computing system 110 in FIG. 1) can compare this against the threshold stopping rate of 3.5 m/s². The vehicle computing system (e.g., vehicle computing system 110 in FIG. 1) determines that the target stopping rate exceeds the threshold stopping rate. In response to determining that the target stopping rate exceeds the threshold stopping rate, the vehicle computing system (e.g., vehicle computing system 110 in FIG. 1) can set the emergency braking flag field for the current trajectory data to true.

FIG. 5 depicts an example diagram for a vehicle controller subsystem 500 associated with determining whether the emergency braking flag is set according to example embodiments of the present disclosure. In this example, the vehicle controller subsystem 500 receives, as input, information about the emergency braking flag 502, desired acceleration 504, velocity (including desired velocity 506 and a feedback signal associated with the velocity 508), and position (including planned position 510 and a feedback signal associated with the actual position 512). The vehicle controller subsystem 500 can, based on the input, generate an acceleration control command 514. For example, the vehicle controller subsystem 500 can, if the emergency braking flag 502 is set to true, the vehicle controller subsystem 500 can use the desired acceleration value 504 directly to generate an acceleration control command 514. If the emergency braking flag 502 is not true, the vehicle controller subsystem 500 can limit to acceleration control command 514 such that it does not exceed a stored threshold stopping value.

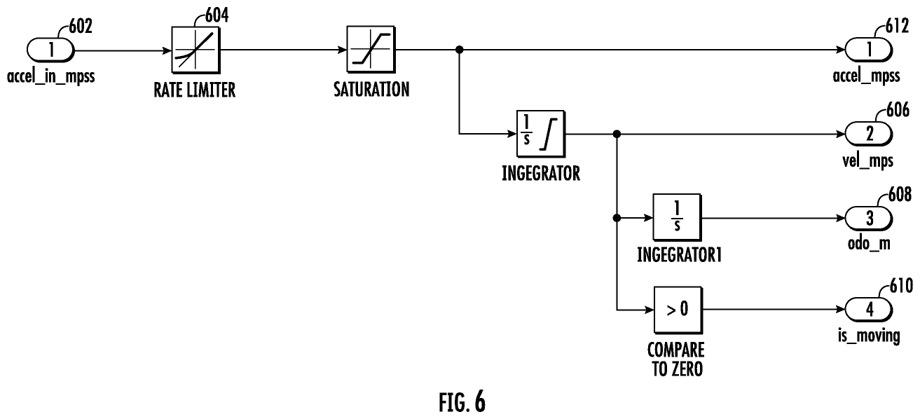

FIG. 6 depicts an example autonomous vehicle response subsystem 600 according to example embodiments of the present disclosure. In some implementations, the subsystems 500 and 600 (and/or their associated functionalities) can be combined, performed the other system, or vice versa. The autonomous vehicle response subsystem 600 can receive a target acceleration 602 (in m/s2) and apply a rate limiter 604 to ensure it does not exceed the maximum stopping rate for the autonomous vehicle (e.g., autonomous vehicle 105 in FIG. 1). As noted above, if the emergency braking flag has been set to true, the maximum stopping rate can be set to the theoretical maximum stopping rate of the autonomous vehicle (e.g., autonomous vehicle 105 in FIG. 1). In some examples, if the emergency braking flag is not set to true, the maximum stopping rate can be set to a predetermined conservative braking rate that is set based on the real-world performance of the model associated with the autonomous vehicle (e.g., autonomous vehicle 105 in FIG. 1).

The target acceleration input 602 can be integrated to determine a target velocity 606 (e.g., the speed at which the vehicle computing system (e.g., vehicle computing system 110 in FIG. 1) has planned for the autonomous vehicle (e.g., autonomous vehicle 105 in FIG. 1) to move), a target location 608 (e.g., a location which the autonomous vehicle (e.g., autonomous vehicle 105 in FIG. 1) is expected to reach within a predetermined time frame), and a determination whether the autonomous vehicle (e.g., autonomous vehicle 105 in FIG. 1) is moving 610. The rate limited target acceleration 612 can be used to control braking for the autonomous vehicle (e.g., autonomous vehicle 105 in FIG. 1).

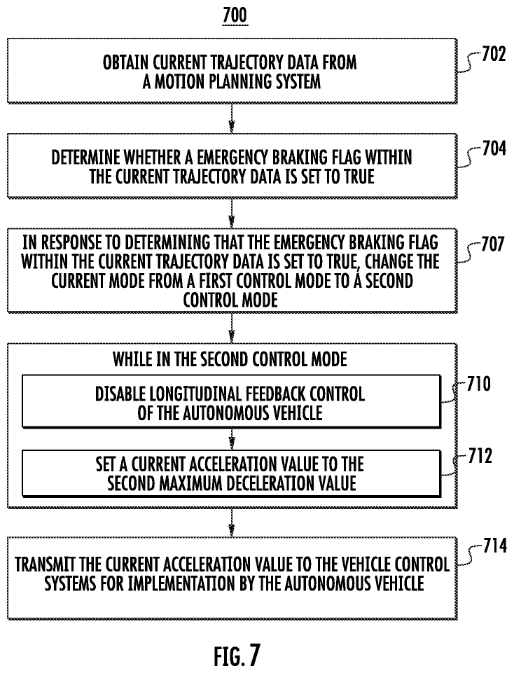

FIG. 7 depicts a flow chart diagram of an example method according to example embodiments of the present disclosure. One or more portions of method 700 can be implemented by one or more computing devices such as, for example, a computing device of an autonomous vehicle (e.g., autonomous vehicle 105) as depicted in FIG. 1. One or more portions of the method 700 described herein can be implemented as an algorithm on the hardware components of the devices described herein (e.g., as in FIG. 1 and FIG. 2C) to, for example, determine control of the braking systems of an autonomous vehicle (e.g., autonomous vehicle 105 in FIG. 1). Although FIG. 7 depicts steps performed in a particular order for purposes of illustration and discussion, method 700 of FIG. 7 is not limited to the particularly illustrated order or arrangement. The various steps of the methods disclosed herein can be omitted, rearranged, combined, and/or adapted in various ways without deviating from the scope of the present disclosure.

The autonomous vehicle (e.g., autonomous vehicle 105 in FIG. 1) can include a vehicle computing system (e.g., vehicle computing system 110 in FIG. 1). The vehicle computing system (e.g., vehicle computing system 110 in FIG. 1) can include a motion planner (e.g., motion planner system 280 in FIG. 2C) and vehicle controller (e.g., vehicle controller 145 in FIG. 1) as described above. The vehicle computing system (e.g., vehicle computing system 110 in FIG. 1) can obtain, at 702, current trajectory data from a motion planning system (e.g., motion planner system 280 in FIG. 2C) of an autonomous vehicle (e.g., vehicle computing system 110 in FIG. 1). In some examples, the current trajectory data comprises target acceleration data. The target acceleration data can include a rate at which the autonomous vehicle (e.g., autonomous vehicle 105 in FIG. 1) is expected to stop, slow down, or otherwise decelerate.

In some examples, the trajectory data includes an expected trajectory for the autonomous vehicle (e.g., autonomous vehicle 105 in FIG. 1). The expected trajectory contains a target progression of the autonomous vehicle (e.g., autonomous vehicle 105 in FIG. 1) over a given amount of time. For example, the trajectory can include a series of target coordinates, each coordinate representing the ideal location of the autonomous vehicle at each of a series of points in time (e.g., 1 second, 2 seconds, 3 seconds, and so on). In some examples, the target progression can include a target velocity, a target acceleration, a target heading, and a target pose for the autonomous vehicle (e.g., autonomous vehicle 105 in FIG. 1) at one or more points in time.

The vehicle computing system (e.g., autonomous vehicle 105 in FIG. 1) can determine, at 704, whether an emergency braking flag within the current trajectory data is set to true based at least in part on the current trajectory data. In some examples, the emergency braking flag indicates the target acceleration data exceeds the first maximum stopping rate. In some examples, the emergency braking flag is set based on a comparison between the target acceleration data and the first maximum stopping rate, such that if the target acceleration data exceeds the first maximum stopping rate, the braking flag is set.

In response to determining that the emergency braking flag within the current trajectory data is set to true, the vehicle computing system (e.g., vehicle computing system 110 in FIG. 1) can, at 707, change a current braking mode from a first braking mode to a second braking mode. The first braking mode can be associated with a first maximum stopping rate and the second braking mode can be associated with a second maximum stopping rate. In some examples, the first braking mode is a standard braking mode and the second braking mode is an emergency braking mode.

In some examples, the first maximum stopping rate can represent a less rapid stopping rate than the second maximum stopping rate. In some examples, the first maximum stopping rate and the second maximum stopping rate can be based on a specific make and model associated with the autonomous vehicle. For example, each vehicle can have properties that include the rate at which is can stop. For example, as the weight of a vehicle increases, the rate at which it can stop decreases. Similarly, the number and quality of stopping mechanisms can influence the rate at which the vehicle can stop. Thus, based on the properties associated with a particular make and model of autonomous vehicle (e.g., autonomous vehicle 105 in FIG. 1), the vehicle computing system (e.g., vehicle computing system 110 in FIG. 1) can access (or determine) a conservatively estimated stopping rate (e.g., the first maximum stopping rate) and a theoretical stopping rate (e.g., the second maximum stopping rate). While in the first braking mode, the vehicle computing system (e.g., vehicle computing system 110 in FIG. 1) can receive velocity error feedback and heading error feedback and can update one or more control messages based on the velocity error feedback and the heading error feedback.

While in the second braking mode, the vehicle computing system (e.g., vehicle computing system 110 in FIG. 1) can, at 710, disable longitudinal feedback control of the autonomous vehicle and, at 712, set a current acceleration value to the second maximum stopping rate. In addition, while in second braking mode the vehicle computing system (e.g., vehicle computing system 110 in FIG. 1) can discard one or more stored control error variables. The vehicle computing system (e.g., vehicle computing system 110 in FIG. 1) can measure an actual stopping rate for the autonomous vehicle (e.g., autonomous vehicle 105 in FIG. 1) once the current acceleration value has been transmitted to the vehicle control system. The vehicle computing system (e.g., vehicle computing system 110 in FIG. 1) can transmit the actual stopping rate to a motion planner for use in motion planning. The vehicle computing system (e.g., vehicle computing system 110 in FIG. 1) can, at 714, transmit the current acceleration value to a vehicle control system for implementation by the autonomous vehicle (e.g., autonomous vehicle 105 in FIG. 1). In some examples, the current acceleration value is transmitted to the vehicle platform which can include the vehicle components that are outside of the autonomy system.

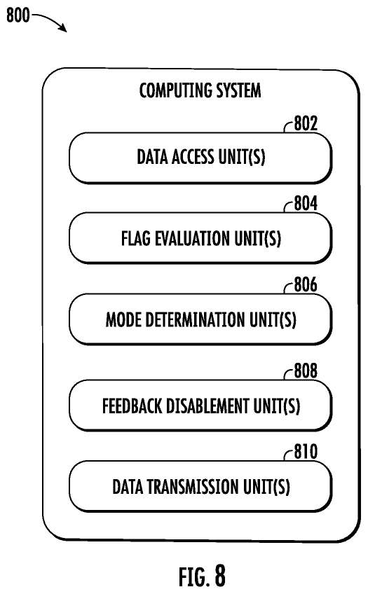

FIG. 8 depicts an example system 800 with units for performing operations and functions according to example aspects of the present disclosure. Various means can be configured to perform the methods and processes described herein. For example, a computing system can include data access unit(s) 802, flag evaluation unit(s) 804, mode determination unit(s) 806, feedback disablement unit(s) 808, data transmission unit(s) 810, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain current trajectory data from a motion planning system of an autonomous vehicle. For example, a vehicle computing system (e.g., vehicle computing system 110 in FIG. 1) can receive data describing a particular trajectory for the autonomous vehicle (e.g., autonomous vehicle 105 in FIG. 1) including an acceleration value, one or more destination coordinates, one or more steering commands, and so on. A data access unit 802 is one example of a means for obtaining current trajectory data from a motion planning system of an autonomous vehicle (e.g., autonomous vehicle 105 in FIG. 1).

The means can be configured to determine whether an emergency braking flag within the current trajectory data is set to true based at least in part on the current trajectory data. For example, the vehicle computing system (e.g., vehicle computing system 110 in FIG. 1) can analyze the trajectory data to determine whether or not the emergency braking flag is set to true. A flag evaluation unit 804 is one example of a means for determining whether an emergency braking flag within the current trajectory data is set to true based at least in part on the current trajectory data.

The means can be configured to, in response to determining that the emergency braking flag within the current trajectory data is set to true, change a current braking mode from a first braking mode to a second braking mode. For example, the vehicle computing system (e.g., vehicle computing system 110 in FIG. 1) can change the autonomous vehicle (e.g., autonomous vehicle 105 in FIG. 1) into an emergency braking mode (e.g., the second braking mode) when the trajectory data indicates that it is necessary. A mode determination unit 806 is one example of a means for, in response to determining that the emergency braking flag within the current trajectory data is set to true, changing a current braking mode from a first braking mode to a second braking mode, wherein the first braking mode is associated with a first maximum stopping rate and the second braking mode is associated with a second maximum stopping rate.

The means can be configured to, while in the second braking mode, disable longitudinal feedback control of the autonomous vehicle (e.g., autonomous vehicle 105 in FIG. 1) and set a current acceleration value to the second maximum stopping rate. Longitudinal feedback control can refer specifically to longitudinal positional feedback control (e.g., in which the position of the autonomous vehicle is tracked and the control of the autonomous vehicle is adjusted when the position of the autonomous vehicle deviates from the planned position of the autonomous vehicle). Longitudinal feedback control can be disabled because, while in the emergency braking mode (e.g., second braking mode), the autonomous vehicle is attempting to stop as soon as possible such that feedback of this type is unnecessary until the vehicle comes to a stop or the autonomous vehicle determines that the emergency braking mode is no longer needed.

For example, the vehicle computing system (e.g., vehicle computing system 110 in FIG. 1) can cease using feedback from the sensors that measure the performance of the autonomous vehicle (e.g., based on the position of the autonomous vehicle (e.g., autonomous vehicle 105 in FIG. 1)) and set the braking value to the maximum possible stopping rate. In some examples, other feedback control mechanisms (e.g., velocity feedback control) can continue to operate while in the second braking mode. In addition, some braking systems, such as an anti-lock braking system, can continue to operate while in the second braking mode. A feedback disablement unit 808 is one example of a means for, while in the second braking mode, disabling positional longitudinal feedback control of the autonomous vehicle (e.g., autonomous vehicle 105 in FIG. 1), and setting a current acceleration value to the second maximum stopping rate.

The means can be configured to transmit the current acceleration value to a vehicle control system for implementation by the autonomous vehicle (e.g., autonomous vehicle 105 in FIG. 1). For example, the vehicle computing system (e.g., vehicle computing system 110 in FIG. 1) transmits command signals to the vehicle control system (e.g., vehicle control system 150 in FIG. 1) to be implemented by the autonomous vehicle (e.g., autonomous vehicle 105 in FIG. 1) itself. A data transmission unit 810 is one example of a means for transmitting the current acceleration value to a vehicle control system (e.g., vehicle control system 150 in FIG. 1) for implementation by the autonomous vehicle (e.g., autonomous vehicle 105 in FIG. 1).

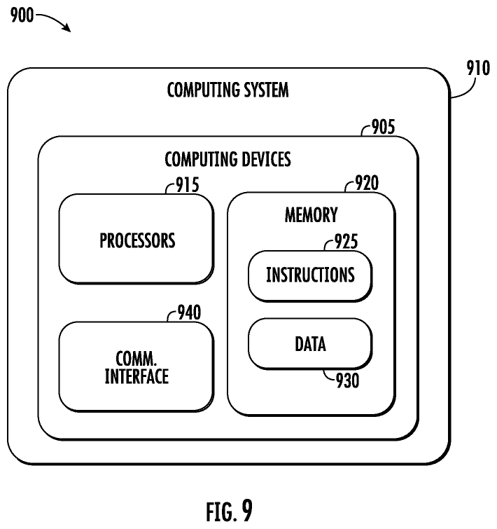

FIG. 9 depicts example system components according to example aspects of the present disclosure. The example system 900 illustrated in FIG. 9 is provided as an example only. The components, systems, connections, and/or other aspects illustrated in FIG. 9 are optional and are provided as examples of what is possible, but not required, to implement the present disclosure. The computing system 900 can be and/or include the vehicle computing system 110 of FIG. 1. The computing system 900 can be associated with a central operations system and/or an entity associated with the vehicle 105 such as, for example, a vehicle owner, vehicle manager, fleet operator, service provider, etc.

The computing device(s) 905 of the computing system 900 can include processor(s) 915 and at least one memory 920. The one or more processors 915 can be any suitable processing device (e.g., a processor core, a microprocessor, an ASIC, an FPGA, a controller, a microcontroller, etc.) and can be one processor or a plurality of processors that are operatively connected. The memory 920 can include one or more non-transitory computer-readable storage media, such as RAM, ROM, EEPROM, EPROM, one or more memory devices, flash memory devices, magnetic disks, data registers, etc., and combinations thereof.

The memory 920 can store information that can be accessed by the one or more processors 915. For instance, the memory 920 (e.g., one or more non-transitory computer-readable storage mediums, memory devices) can include computer-readable instructions 925 that can be executed by the one or more processors 915. The instructions 925 can be software written in any suitable programming language or can be implemented in hardware. Additionally, or alternatively, the instructions 925 can be executed in logically and/or virtually separate threads on processor(s) 915

For example, the memory 920 on-board the vehicle 105 can store instructions 925 that when executed by the one or more processors 915 cause the one or more processors 915 (e.g., in the vehicle computing system 110) to perform operations such as any of the operations and functions of the computing device(s) 905 and/or vehicle computing system 110 (and its sub-systems (e.g., the motion planner system 280, etc.)), any of the operations and functions for which the vehicle computing system 110 (and/or its subsystems) are configured, and/or any other operations and functions described herein.

The memory 920 can store data 930 that can be obtained (e.g., received, accessed, written, manipulated, created, generated, etc.) and/or stored. The data 930 can include, for instance, services data (e.g., trip data, route data, user data, etc.), sensor data, map data, perception data, prediction data, motion planning data, target acceleration data, braking flag data, and/or other data/information as described herein. In some implementations, the computing device(s) 905 can obtain data from one or more memories that are remote from the autonomous vehicle 105.

The computing device(s) 905 can also include a communication interface 940 used to communicate with one or more other system(s) (e.g., the remote computing system). The communication interface 940 can include any circuits, components, software, etc. for communicating via one or more networks (e.g., network(s)). In some implementations, the communication interface 940 can include, for example, one or more of: a communications controller, a receiver, a transceiver, a transmitter, a port, conductors, software, and/or hardware for communicating data.

Computing tasks discussed herein as being performed at computing device(s) remote from the autonomous vehicle can instead be performed at the autonomous vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure cover such alterations, variations, and/or equivalents.

What is claimed is:

1. A computer-implemented method for implementing autonomous vehicle emergency braking, the method comprising:
obtaining, by a vehicle controller comprising one or more processors, current trajectory data from a motion planning system of an autonomous vehicle;
determining, by the vehicle controller, whether an emergency braking flag is set to true based at least in part on the current trajectory data;
in response to determining that the emergency braking flag within the current trajectory data is set to true, changing, by the vehicle controller, a current braking mode of the autonomous vehicle from a first braking mode to a second braking mode, wherein the first braking mode is associated with a first maximum stopping rate and the second braking mode is associated with a second maximum stopping rate;
while in the second braking mode:
setting, by the vehicle controller, a current acceleration value to the second maximum stopping rate; and
transmitting, by the vehicle controller, the current acceleration value for implementation by the autonomous vehicle.

2. The computer-implemented method of claim 1, further comprising, while in the second braking mode:
disabling, by the vehicle controller, longitudinal position feedback control of the autonomous vehicle.

3. The computer-implemented method of claim 1, wherein the current trajectory data comprises target acceleration data.

4. The computer-implemented method of claim 3, wherein the emergency braking flag indicates the target acceleration data exceeds the first maximum stopping rate.

5. The computer-implemented method of claim 3, wherein the emergency braking flag is set based on a comparison between the target acceleration data and the first maximum stopping rate, such that if the target acceleration data matches or exceeds the first maximum stopping rate, the emergency braking flag is set.

6. The computer-implemented method of claim 1, wherein the first braking mode is a standard braking mode and the second braking mode is an emergency braking mode.

7. The computer-implemented method of claim 1, wherein the first maximum stopping rate represents a less rapid stopping rate than the second maximum stopping rate.

8. The computer-implemented method of claim 1, wherein the first maximum stopping rate and the second maximum stopping rate are based on a specific make and model associated with the autonomous vehicle.

9. The computer-implemented method of claim 1, wherein the trajectory data includes an expected trajectory for the autonomous vehicle.

10. The computer-implemented method of claim 9, wherein the expected trajectory contains a target progression of the autonomous vehicle over a given amount of time.

11. The computer-implemented method of claim 10, wherein the target progression includes a target velocity, a target acceleration, a target heading, and a target pose for the autonomous vehicle at one or more points in time.

12. A computing system for autonomous vehicle emergency braking, the system comprising:
one or more processors and one or more non-transitory computer-readable memories; wherein the one or more non-transitory computer-readable memories store instructions that, when executed by the processor, cause the computing system to perform operations, the operations comprising:
obtaining current trajectory data from a motion planning system associated with the autonomous vehicle;
determining whether a braking emergency flag within the current trajectory data is set to true;
in response to determining that the emergency braking flag within the current trajectory data is set to true, changing a current braking mode from a first braking mode to a second braking mode, wherein the first braking mode is associated with a first maximum stopping rate and the second braking mode is associated with a second maximum stopping rate;
while in the second braking mode:
setting a current acceleration value to the second maximum stopping rate; and
transmitting the current acceleration value for implementation by the autonomous vehicle.

13. The computing system of claim 12, wherein while in the first braking mode, the computing system receives velocity error feedback, positional error feedback, and heading error feedback.

14. The computing system of claim 13, wherein, while in the first braking mode, the computing system can update trajectory data based on the velocity error feedback and the heading error feedback.

15. The computing system of claim 12, wherein while in the second braking mode the operations further comprise:
discarding one or more stored control error variables.

16. The computing system of claim 12, wherein further comprising while in the second braking mode:
measuring an actual stopping rate for the autonomous vehicle once the current acceleration value has been transmitted to a vehicle control system.

17. The computing system of claim 16, further comprising while in the second braking mode:
disabling longitudinal position feedback control of the autonomous vehicle.

18. An autonomous vehicle, comprising:
one or more processors; and
one or more non-transitory computer-readable media that collectively store instructions that, when executed by the one or more processors, cause the one or more processors to perform operations, the operations comprising:
generating, by a motion planner associated with the autonomous vehicle, trajectory data for the autonomous vehicle;
determining, by the motion planner and based on data describing positions of one or more obstacles, a target stopping rate associated with the trajectory data;
in accordance with a determination that the target stopping rate exceeds a first maximum stopping rate, setting, by the motion planner, an emergency braking flag in the trajectory data to true; and
transmitting, to a vehicle controller, the trajectory data for the autonomous vehicle.

19. The autonomous vehicle of claim 18, further comprising:
receiving, by the vehicle controller from the motion planner, the trajectory data for the autonomous vehicle;
determining, by the vehicle controller, whether an emergency braking flag within the trajectory data is set to true; and
in response to determining that the emergency braking flag within the trajectory data is set to true, changing, by the vehicle controller, a current braking mode from a first braking mode to a second braking mode, wherein the first braking mode is associated with a first maximum stopping rate and the second braking mode is associated with a second maximum stopping rate.

20. The autonomous vehicle of claim 18, the operations further comprising:
measuring, by the autonomous vehicle, an actual stopping rate for the autonomous vehicle once a current acceleration value has been transmitted; and
transmitting, by the autonomous vehicle, the actual stopping rate to the motion planner for use in motion planning.
